(19) United States
(12) Patent Application Publication
(10) Pub. No.: US 2006/0009890 A1
(43) Pub. Date: Jan. 12, 2006

(54) Method and device for operating a vehicle

(76) Inventors: Dirk Meister, Moeglingen (DE); Stephan Eisenlauer, Leonberg (DE)

Correspondence Address: KENYON & KENYON, ONE BROADWAY, NEW YORK, NY, 10004, US

(21) Appl. No.: 11/170,464

(22) Filed: Jun. 28, 2005

(30) Foreign Application Priority Data
Jul. 8, 2004 (DE) 102004032983.4

(51) Int. Cl. G06F 17/00

(52) U.S. Cl. 701/36; 701/1

(57) ABSTRACT

A method and a device for operating a vehicle in which a plurality of vehicle functions are activatable or de-activatable. A first profile is provided, according to which a first configuration is predefined, which specifies how the individual vehicle functions are to be set. Furthermore, a second profile is provided, according to which a second configuration is predefined, which specifies how the individual vehicle functions are to be set. The setting of at least one of the vehicle functions is different in the two profiles. In a first predefined driving situation, the vehicle functions are configured according to the first profile, and in a second predefined driving situation the vehicle functions are configured according to the second profile.

### BACKGROUND INFORMATION

Methods and devices for operating a vehicle in which a plurality of vehicle functions are activatable or de-activatable are known. These include, for example, a function for regulating the vehicle velocity which can be activated or de-activated by the driver via a cruise control lever for example, and a function for the vehicle lights, which can be activated or de-activated via a light switch for turning the vehicle headlights on or off for example.

European Patent No. EP 0 884 709 describes a device for providing information about the particular predefined maximum velocity in a motor vehicle when traveling on stretches of road for which speed limits are prescribed. For this purpose, the prescribed speed limit values of the particular stretches of road are stored in a memory of the device, the stretch of road being traveled being determinable with the aid of a positioning device, and the particular maximum velocity being readable for the particular stretch of road determined. For vehicles having a cruise control system, the maximum velocity values read may be additionally or alternatively supplied to the cruise control system. This embodiment is also applicable to motor vehicles equipped with autonomous driving systems.

Country-specific implementations of different vehicle functions are currently established by a country coding on the CAN bus of the vehicle. However, if such a vehicle is registered in a country other than its country of origin, problems may arise from the fact that the country-specific implementation of the vehicle functions for the country of origin is no longer admissible in the country different from the country of origin.

### SUMMARY OF THE INVENTION

The method and device according to the present invention for operating a vehicle has the advantage over the related art that a first profile is provided, according to which a first configuration is predefined, which specifies how the individual vehicle functions are to be set, and a second profile is provided, according to which a second configuration is predefined, which specifies how the individual vehicle functions are to be set, the setting of at least one of the vehicle functions being different in the two profiles, and the vehicle functions are configured according to the first profile in a first predefined driving situation, and the vehicle functions are configured according to the second profile in a second predefined driving situation. In this way, the individual vehicle functions may be configured as a function of the current driving situation and thus adapted to the current driving situation in an optimum manner. In particular, different profiles may be defined for different countries for configuring the individual vehicle functions. Depending on the country where the vehicle is at a given time, the individual vehicle functions may then be configured according to a profile predefined for that country. The individual vehicle functions are thus automatically adapted to the country-specific conditions such as licensing regulations. In this way vehicles so equipped may be driven in different countries without problems, it being possible to conveniently switch between different profiles for the individual vehicle functions. The use of different profiles for the individual vehicle functions as a function of the current driving situation also makes a central coordination of these vehicle functions possible, so that a check for the required vehicle function setting or whether it is to be activated or de-activated does not have to be performed for each vehicle function individually as a function of the current driving situation.

It is advantageous in particular if the first driving situation is defined by a first location, and the second driving situation is defined by a second location which is different from the first location. In this way, the individual vehicle functions may be configured as a function of the location, in particular as a function of the country where the vehicle is located.

Another advantage results if the first driving situation is defined by the reception of first wireless signals and the second driving situation is defined by the reception of second wireless signals. In this way, the individual vehicle functions may be configured differently as a function of the various wireless signals received. Differentiated remote operation of the vehicle, for example, is also possible in this way. However, when the wireless signals are positioning signals, the individual vehicle functions may be configured as a function of the location in a particularly easy manner in this way.

It is furthermore advantageous if the vehicle functions represent safety functions. In this way, the individual vehicle functions may be configured, for example, to different vehicle safety requirements in different countries. It is furthermore advantageous if the first configuration and/or the second configuration specifies for at least one of the vehicle functions whether it is to be activated or de-activated. In this way, the configuration is defined as simply turning such a vehicle function on or off as a function of the current driving situation and may thus be implemented in a particularly simple manner.

It is furthermore advantageous if the first configuration specifies a first value for a parameter of one of the vehicle functions and the second configuration specifies a second value for the parameter of this vehicle function. In this way the corresponding vehicle function may be configured in a more differentiated manner as a function of the current driving situation as may be done, for example, for the specification of a maximum velocity for a cruise control system.

### BRIEF DESCRIPTION OF THE DRAWINGS

FIG. 1 shows a block diagram of the device according to the present invention.

FIG. 2 shows a flow chart for an exemplary sequence of the method according to the present invention.

### DETAILED DESCRIPTION

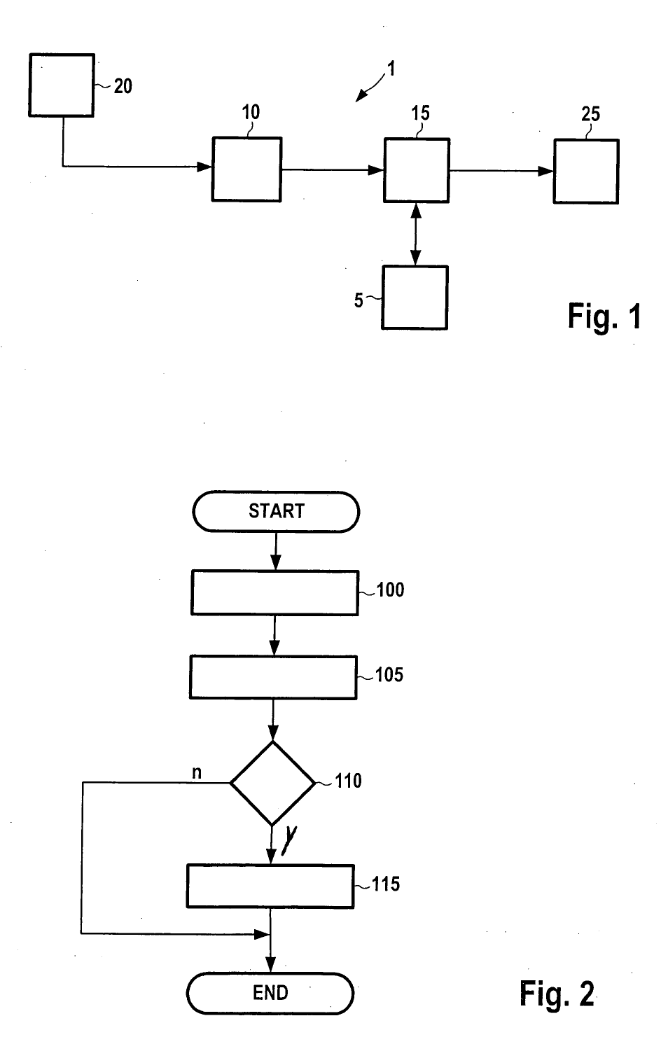

In FIG. 1, the symbol 1 identifies a device according to the present invention for operating a vehicle. It is to be assumed, for example, that device 1 is implemented in an engine controller of the vehicle as software and/or hardware. Device 1 includes a receiver 20, which is equipped, for example, with an antenna for receiving wireless signals, positioning signals in particular. The signals received and processed by receiver 20 are supplied to a driving situation determining unit 10, which determines the current driving situation of the vehicle from the signals received by receiver 20. Driving situation determining unit 10 forwards the current driving situation of the vehicle thus determined to an analyzer unit 15, which is connected to a profile specifying unit 5. In profile specifying unit 5, which may be designed as a non-volatile memory, for example, a profile is assigned to each of different predefined driving situations; a configuration specifying how individual vehicle functions are to be set in the presence of the assigned predefined driving situation is specified according to the profile. Analyzer unit 15 compares the current driving situation of the vehicle determined by driving situation determining unit 10 with the predefined driving situations in profile specifying unit 5. If the current driving situation matches one of the predefined vehicle functions, analyzer unit 15 reads the profile assigned to this predefined driving situation for configuring the individual vehicle functions and forwards this profile to an implementing unit 25 for implementation.

The profile to be set is then implemented by triggering the individual vehicle functions appropriately, in particular by activating or de-activating the individual vehicle functions according to the profile determined by analyzer unit 15 for the current driving situation or by defining a parameter value for at least one of these vehicle functions according to the profile determined by analyzer unit 15 for the current driving situation.

In the following the procedure according to the present invention is presented in a more specific manner by way of an example. A first profile may thus be stored in profile specifying unit 5, according to which a first configuration is predefined, which specifies how individual vehicle functions are to be set in the presence of a first predefined driving situation. Furthermore, a second profile is stored in profile specifying unit 5, according to which a second configuration is predefined, which specifies how these individual vehicle functions are to be set in the presence of a second predefined driving situation, the setting of at least one of the above-mentioned vehicle functions being different in the first profile and the second profile. If analyzer unit 15 now determines a current driving situation, which corresponds to the first predefined driving situation, it selects, from profile specifying unit 5, the assigned first profile for implementation. If, however, analyzer unit 15 determines a current driving situation, which corresponds to the second predefined driving situation, it selects, from profile specifying unit 5, the second profile for implementation. The above-mentioned vehicle functions may thus be configured according to the first profile in the presence of the first predefined driving situation and according to the second profile in the presence of the second predefined driving situation.

Of course, more than two different driving situations may also be predefined in profile specifying unit 5, a specific profile for configuring the above-mentioned vehicle functions in profile specifying unit 5 being assigned to each. Not all profiles have to differ from one another, i.e., two profiles for different predefined driving situations may be identical. At least two of the profiles stored in profile specifying unit 5 for different predefined driving situations should, however, differ from one another according to the present invention.

In general, different driving situations may be differentiated simply by the fact that they correspond to different wireless signals received by receiver 20. For example, the first predefined driving situation may be defined by the reception of first wireless signals and the second predefined driving situation may be defined by the reception of second wireless signals. If additional driving situations are predefined in profile specifying unit 5, these may also be defined by the reception of corresponding wireless signals. To distinguish the different predefined driving situations from one another in profile specifying unit 5, the wireless signals assigned to them must also differ.

The wireless signals may have different meanings. According to a first exemplary embodiment, the wireless signals may originate from a remote operating device, for example. For example, if the vehicle has been stolen, the owner of the vehicle may send different wireless signals to the vehicle via the remote operating device to configure the above-mentioned vehicle functions differently. In the simplest case, one, more, or all of the above-mentioned vehicle functions may be activated or one, more, or all of the above-mentioned vehicle functions may be de-activated depending on the predefined profile in profile specifying unit 5. For example, according to a first profile, an automatic immobilizer may be activated as a first vehicle function and a navigation device may be de-activated as second vehicle function. Conversely, according to a second predefined profile, the automatic immobilizer may be de-activated and the navigation device activated. If the vehicle has been purloined from the owner, the owner may transmit, for example, first wireless signals to the vehicle, i.e., to receiver 20 of the vehicle according to a first remote operation function, which selects the first profile from profile specifying unit 5 to immobilize the vehicle if possible. If the owner has found his vehicle again, he may re-activate it according to a second remote operation function by sending second wireless signals from his remote operating device, if the second wireless signals result in the second profile being selected from profile specifying unit 5 for implementation.

Immobilization of the vehicle may be facilitated if the first profile also provides for the steering function being de-activated, i.e., locked, while the second profile provides for re-activation of the steering function. The configurations of the above-mentioned vehicle functions predefined by the two profiles are also characterized in that different vehicle functions are activated or de-activated depending on the configuration. In general, at least one of the above-mentioned vehicle functions is to be activated or de-activated for the above-mentioned configurations in this case. The first profile may only provide the activation of the automatic immobilizer, and the second profile only the de-activation of the automatic immobilizer.

In addition, in the above-mentioned example of the remote operation, a first value for a parameter of one of the vehicle functions is specified for the first profile, and a second value for the parameter of this vehicle function is specified for the second profile. This vehicle function may be a limitation of the maximum vehicle velocity, for example, the permissible maximum vehicle velocity being the parameter of this vehicle function. Thus, for example, a value of 10 km/h may be specified for the maximum vehicle velocity in the first profile, and a value of 250 km/h for the maximum vehicle velocity in the second profile. In this way immobilization of a stolen vehicle is facilitated by the first profile.

According to a second example, the above-mentioned wireless signals received by receiver 20 may be positioning signals, for example, positioning signals received from appropriate satellites according to the GPS (Global Positioning System). Using the positioning data received, driving situation determining unit 10 then determines the current position of the vehicle as the current driving situation. In this case, different locations may be predefined in profile specifying unit 5, and a profile for the configuration of different vehicle functions may be assigned to each location. If the current location of the vehicle determined by driving situation determining unit 10 matches one of the locations predefined in profile specifying unit 5, the above-mentioned vehicle functions are set according to the configuration assigned to this location. Thus, for example, a first predefined driving situation may be defined by a first location, and a second predefined driving situation may be defined by a second location which is different from the first location. Additional predefined driving situations may also each be defined by an additional location, a different location being assigned to each of the different predefined driving situations. This should rule out the situation where two different predefined driving situations have the same location. However, different driving situations, i.e., different locations, may each be assigned the same profile for configuring the vehicle functions. It should, however, be assumed that for at least two different locations different profiles are also stored in profile specifying unit 5.

In the simplest case, different countries may be predefined as locations. Driving situation determining unit 10 then determines, on the basis of the positioning data received, the country in which the vehicle is located at the time. The profiles in profile specifying unit 5 are then assigned to different countries. The vehicle functions are thus configured in a country-specific manner according to the profiles stored in profile specifying unit 5. Therefore, if, on the basis of the positioning data received, it is determined by driving situation determining unit 10 that the vehicle is currently located in a first country, analyzer unit 15 compares this first country with the countries stored in profile specifying unit 5. If the country currently determined by driving situation determining unit 10 matches one of the predefined countries stored in profile specifying unit 5, analyzer unit 15 takes the profile assigned to this predefined country in profile specifying unit 5 for configuring the vehicle functions and relays this profile to implementing unit 25 for implementation.

Also in this example, one, more, or all of the vehicle functions affected by the profile may be activated or one, more, or all of these vehicle functions may be de-activated according to the specifications of profile specifying unit 5, depending on the country in which the vehicle is located at the time. This is of particular importance for those vehicle functions which represent safety functions. Such vehicle functions include, for example, an automatic emergency braking function, electronic stability programs which use active intervention in the longitudinal and/or transverse dynamics of the vehicle and/or simply a light function of the vehicle according to which the headlights of the vehicle are to be turned on or off. Thus, for countries in which driver assistance functions which include active intervention in the longitudinal and/or transverse dynamics are not allowed by those countries' regulations, those functions are de-activated according to the profiles assigned to those countries on the basis of the positioning data received as long as the vehicle is being driven there. In other countries, where these driver assistance functions are allowed, these functions may be re-activated by the appropriate profile specification in profile specifying unit 5.

If the vehicle must have its headlights on when driven in a certain country, the profile assigned to this country provides that the headlights must be activated. As soon as the vehicle enters this country and driving situation determining unit 10 determines, on the basis of the positioning data received, that the vehicle is located in this country, the vehicle lights are activated according to the assigned profile for turning the headlights on.

FIG. 2 shows a flow chart for an exemplary sequence of the method according to the present invention. After the start of the program, positioning information is received in receiver 20 at a program point 100. The program then branches off to a program point 105. At program point 105, driving situation determining unit 10 determines, on the basis of the positioning information received, the country in which the vehicle is located at that time. The program then branches off to a program point 110.

At program point 110, analyzer unit 15 verifies whether a profile is stored for this country in profile specifying unit 5. If this is the case, the program branches off to a program point 115; otherwise the program is terminated.

At program point 115, analyzer unit 15 selects the profile predefined for and assigned to the country currently determined by driving situation determining unit 10 for configuring the vehicle functions from profile specifying unit 5, and causes this profile to be implemented by implementing unit 25, i.e., the corresponding vehicle functions are configured and implemented according to the selected profile. The implementation itself is no longer an object of the present invention and may take place in a manner known to those skilled in the art.

Also in this second example, a first value for a parameter of this vehicle function may be specified for at least one of the vehicle functions according to a first configuration and a second value for this parameter of this vehicle function may be specified for a second configuration. As described in the first example, this may again be a velocity limiting function which limits the velocity of the vehicle to a predefined maximum velocity as a parameter. Thus, different values for the maximum vehicle velocity may be stored for the different countries in the individual profiles in profile specifying unit 5. Depending on the country in which the vehicle is traveling, the appropriate maximum velocity value is then selected according to the profile assigned to this country, and the velocity of the vehicle is limited to this maximum velocity. Thus, for example, in a profile assigned to the country France, the value of 130 km/h is specified as the maximum velocity value, while for Germany no value for the maximum velocity is stored in the assigned profile. Thus, no vehicle velocity limitation takes place in Germany, while in France the maximum vehicle velocity is automatically limited to 130 km/h.

A central configuration of different vehicle functions is thus enabled by the method according to the present invention and the device according to the present invention as a function of the driving situation of the vehicle. This is considerably more flexible compared to a fixed preset configuration of the vehicle functions and makes uncomplicated adaptation of the configuration to different driving situations possible, where it is unnecessary to configure each individual vehicle function independently. Particularly simple configurations involve the activation or de-activation of different vehicle functions, but also the specification of different parameter values for a vehicle function.

According to the present invention, at least two profiles for setting or configuring at least one of the corresponding vehicle functions differ from one another.

What is claimed is:

1. A method for operating a vehicle in which a plurality of vehicle functions are activatable or de-activatable, the method comprising:
providing a first profile, according to which a first configuration is predefined, which specifies how individual vehicle functions are to be set; and
providing a second profile, according to which a second configuration is predefined, which specifies how individual vehicle functions are to be set,
wherein a setting of at least one of the vehicle functions is different in the first and second profiles, and
wherein the vehicle functions are configured according to the first profile in a first predefined driving situation, and the vehicle functions are configured according to the second profile in a second predefined driving situation.

2. The method according to claim 1, wherein the first driving situation is defined by a first location, and the second driving situation is defined by a second location which is different from the first location.

3. The method according to claim 1, wherein the first driving situation is defined by a reception of first wireless signals and the second driving situation is defined by a reception of second wireless signals.

4. The method according to claim 1, wherein the vehicle functions represent safety functions.

5. The method according to claim 1, wherein at least one of the first configuration and the second configuration specifies for at least one of the vehicle functions whether it is to be one of activated and de-activated.

6. The method according to claim 1, wherein the first configuration specifies a first value for a parameter of one of the vehicle functions and the second configuration specifies a second value for the parameter of the one of the vehicle functions.

7. A device for operating a vehicle in which a plurality of vehicle functions are activatable or de-activatable, the device comprising:
a profile specifying unit for specifying a first profile, according to which a first configuration is predefined, which specifies how individual vehicle functions are to be set, and for specifying a second profile, according to which a second configuration is predefined, which specifies how individual vehicle functions are to be set, the setting of at least one of the vehicle functions being different in the first and second profiles;
a driving situation determining unit for determining a current driving situation; and
an analyzer unit for selecting the vehicle functions according to the first profile in a first predefined driving situation and for selecting the vehicle functions according to the second profile in a second predefined driving situation.
